(19) United States
(12) Patent Application Publication
(10) Pub. No.: US 2024/0337841 A1
(43) Pub. Date: Oct. 10, 2024

(54) AUGMENTED REALITY SMARTGLASSES DISPLAY CALIBRATION IN THE PRESENCE OF PRESCRIPTION LENSES

(71) Applicant: GOOGLE LLC, Mountain View, CA (US)

(72) Inventors: Xi Chen, Mountain View, CA (US); Qianli Ma, Cambridge (CA); Lloyd Frederick Holland, Waterloo (CA)

(21) Appl. No.: 18/260,867

(22) PCT Filed: Jul. 21, 2022
(86) PCT No.: PCT/US2022/074005

§ 371 Date: Jul. 10, 2023

(51) Int. Cl. G02B 27/01

(52) U.S. Cl. CPC G02B 27/0172; G02B 2027/011; G02B 2027/0138; G02B 2027/014; G02B 2027/0178

(57) ABSTRACT

Techniques of correcting wavefronts from prescription lenses for image calibration in a smartglasses assembly includes correcting wavefront error at a calibration camera by performing a phase modulation of optical wave-fronts emanating from the back surface of a prescription lens in a smartglasses assembly prior to the optical wavefronts being detected by the calibration camera. For example, when collimated light from, e.g., a waveguide disposed within a rim portion of a smartglasses frame, is incident on a prescription lens, that lens induces a wavefront aberration that would be corrected in the prescribed user's eye. In an image calibration, however, there is no such correcting eye so a correction mechanism that corrects the wavefront aberration should be placed in an eye plane related to a location of an eye of the user when the user wears the smartglasses assembly.

### BACKGROUND

Augmented reality (AR) is an interactive experience of a real-world environment where the objects that reside in the real world are enhanced by computer-generated perceptual information, sometimes across multiple sensory modalities, including visual, auditory, and/or haptic. Some AR systems provide such an interactive experience using smartglasses that can provide visual information via a camera mounted on a frame and waveguides and lenses in the frame, and audio and tactile information via the frame.

### SUMMARY

Implementations described herein are related to performing display calibration in smartglasses when the smartglasses lenses are manufactured according to a prescription from an eye professional. For example, a smartglasses user may wear corrective lenses for, e.g., near/far-sightedness, astigmatism, progressive, etc., according to a lens prescription written by, e.g., an optometrist, and smartglasses may also be manufactured using such corrective lenses. Nevertheless, this makes display calibration and measurement in such smartglasses difficult because the calibration assumes that illumination incident on a calibration camera emanates from well-corrected lenses. Accordingly, in the presence of corrective lenses a phase modulation device may be inserted between the corrective lenses and the calibration camera or measurement instrument such that the illumination incident on a calibration camera appears to derive from well-corrected lenses. This enables display calibration for smartglasses independent of any lens prescription.

In one general aspect, a method can include causing, by processing circuitry, a waveguide inside of a frame of a smartglasses assembly to generate electromagnetic radiation as a nominal wavefront, the nominal wavefront being refracted by a prescription lens mounted in a lens holder portion of the frame to produce a distorted wavefront propagating in a direction toward an eye plane related to a location of an eye of a user when the user wears the smartglasses assembly. The method can also include producing a corrected wavefront by generating a compensating phase modulation at the eye plane, the compensating phase modulation being configured to interfere with the distorted wavefront at the eye plane. The method can further include performing an image calibration operation based on a measurement of the corrected wavefront at a calibration camera.

In another general aspect, an image calibration system for a smartglasses assembly includes a compensating phase modulation device at an eye plane related to a location of an eye of a user when the user wears the smartglasses assembly. The image calibration system also includes a calibration camera. The image calibration system further includes at least one processor. The at least one processor is configured to cause a waveguide inside of a frame of the smartglasses assembly to generate electromagnetic radiation as a nominal wavefront, the nominal wavefront being refracted by a prescription lens mounted in a lens holder portion of the frame to produce a distorted wavefront propagating in a direction toward an eye plane related to a location of an eye of a user when the user wears the smartglasses assembly. The at least one processor is also configured to produce a corrected wavefront by causing the compensating phase modulation device to generate a compensating phase modulation at the eye plane, the compensating phase modulation being configured to interfere with the distorted wavefront at the eye plane. The at least one processor is further configured to perform an image calibration operation based on a measurement of the corrected wavefront at the calibration camera.

In another general aspect, a computer program product comprises a non-transitory storage medium, the computer program product including code that, when executed by processing circuitry, causes the processing circuitry to perform a method. The method can include causing a waveguide inside of a frame of a smartglasses assembly to generate electromagnetic radiation as a nominal wavefront, the nominal wavefront being refracted by a prescription lens mounted in a lens holder portion of the frame to produce a distorted wavefront propagating in a direction toward an eye plane related to a location of an eye of a user when the user wears the smartglasses assembly. The method can also include producing a corrected wavefront by generating a compensating phase modulation at the eye plane, the compensating phase modulation being configured to interfere with the distorted wavefront at the eye plane. The method can further include performing an image calibration operation based on a measurement of the corrected wavefront at a calibration camera.

The details of one or more implementations are set forth in the accompanying drawings and the description below. Other features will be apparent from the description and drawings, and from the claims.

### BRIEF DESCRIPTION OF THE DRAWINGS

FIG. 1A illustrates an example system, in accordance with implementations described herein.

FIG. 1B is a front view, FIG. 1C is a rear view, and FIG. 1D is a perspective view, of the example head mounted wearable device shown in FIG. 1A, in accordance with implementations described herein.

FIG. 2 is a diagram illustrating an example optical system in a smartglasses assembly used to form a display image to a user having a prescription lens.

FIG. 3A is a diagram illustrating an example smartglasses display calibration system that uses a transmissive spatial light modulator.

FIG. 3B is a diagram that illustrates an example smartglasses display calibration system that uses a reflective spatial light modulator.

FIG. 4 is a diagram that illustrates example processing circuitry configured to perform smartglasses display calibration.

FIG. 5 is a flow chart that illustrates an example method, according to disclosed implementations.

FIG. 6 is a diagram that illustrates an example of a computer device and a mobile computer device that can be used to implement the described techniques.

FIG. 7 is a diagram that illustrates an example of a distributed computer device that can be used to implement the described techniques.

### DETAILED DESCRIPTION

A challenge in AR is providing calibrated images to users independent of their lens prescriptions. For example, prescription lenses in smartglasses may introduce wavefront aberrations at a camera used for calibrating images in smartglasses. As it would be difficult to construct a different calibration system for every prescription in use, such calibration systems use substantially aberration-free (i.e., substantially diffraction-limited) images.

A conventional approach to calibrating images in smartglasses involves the use of a phoropter. Nevertheless, there can be issues related to the use of a phorometer for calibrating images in the presence of prescription lenses. For example, phorometers employ a plethora of moving parts, e.g., switching out lenses of varying optical properties such as focusing power and prescription parameters such as SPH, CYL, and Axis. A technical problem with such large sizes and numbers of moving parts can render the calibration step awkward, burdensome, expensive, and unsuitable in a production environment.

In accordance with the implementations described herein, a technical solution to the above-described technical problem includes correcting wavefront error at a calibration camera by performing a phase modulation of optical wavefronts emanating from the back surface of a prescription lens in a smartglasses assembly prior to the optical wavefronts being detected by the calibration camera. A technical effect of the technical solution is that the phase modulation corrects distorted wavefronts induced by prescription lenses while requiring no mechanical moving parts and may be compact, simplifying and lowering cost of calibration of smartglasses with prescription lenses.

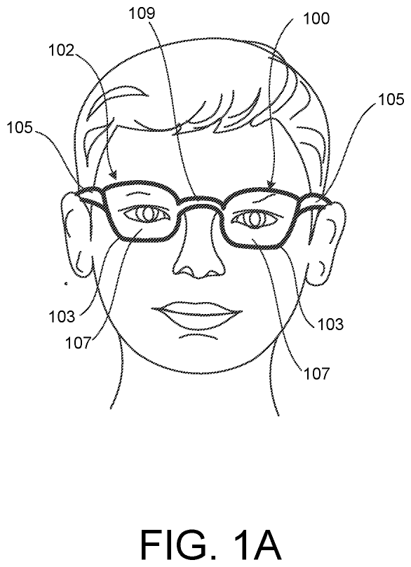

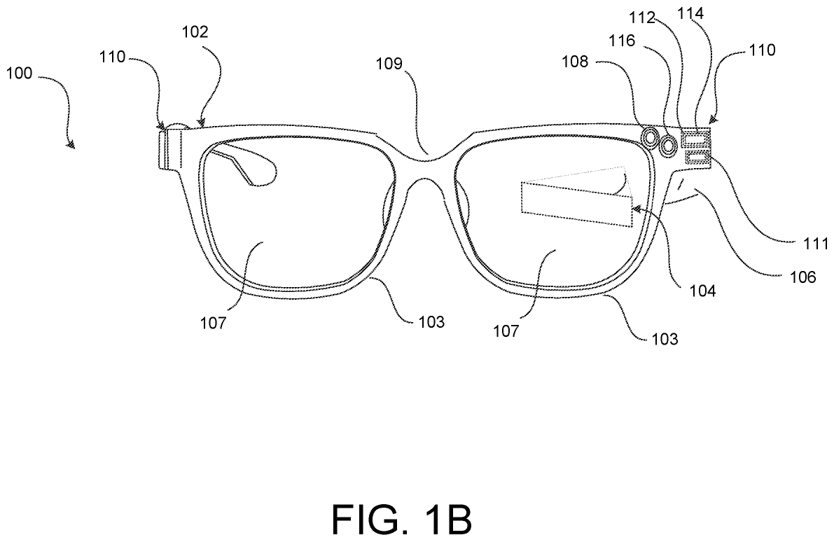

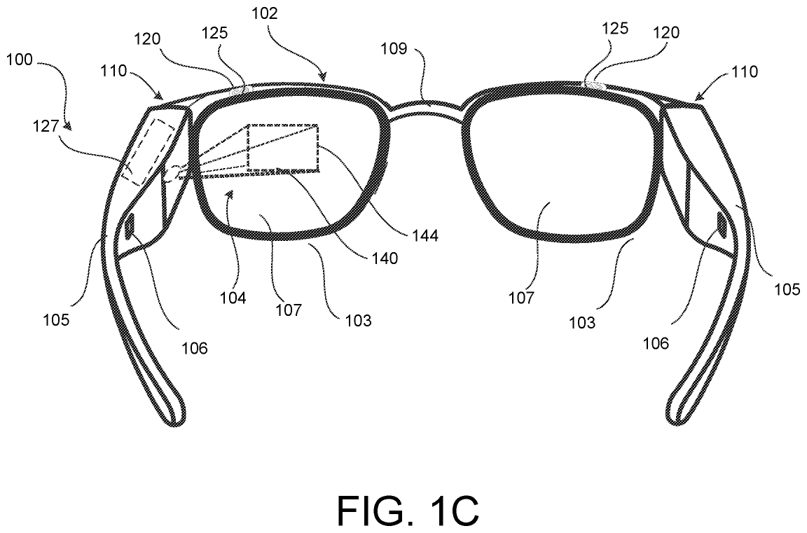

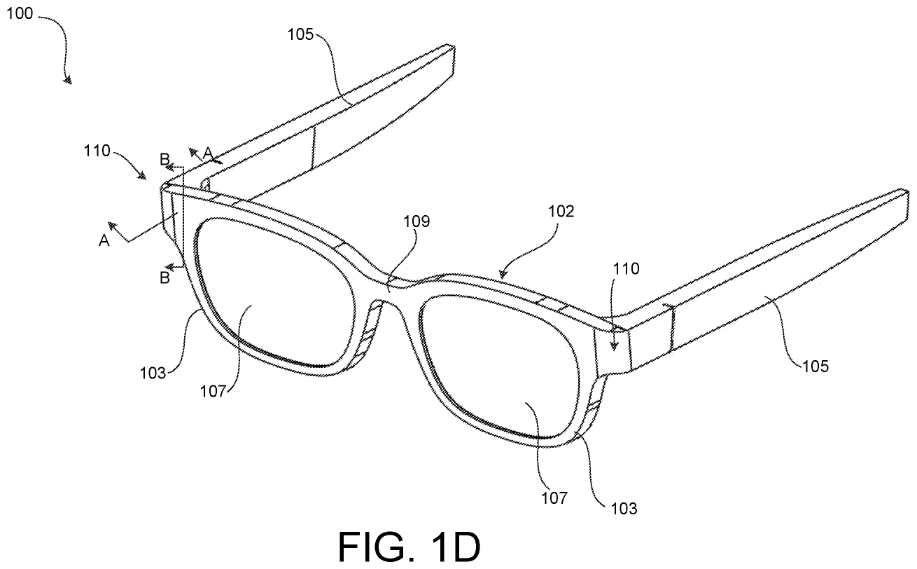

FIG. 1A illustrates a user wearing an example head mounted wearable device for use in an augmented reality (AR) system. In this example, the example head mounted wearable device 100 is in the form of example smartglasses including display capability and computing/processing capability, for purposes of discussion and illustration. The principles to be described herein may be applied to other types of eyewear, both with and without display capability and/or computing/processing capability. FIG. 1B is a front view, FIG. 1C is a rear view, and FIG. 1D is a perspective view, of the example head mounted wearable device 100 shown in FIG. 1A. As noted above, in some examples, the example head mounted wearable device 100 may take the form of a smartglasses assembly, AR glasses, AR goggles, AR headsets, or augmented reality glasses.

As shown in FIGS. 1B-1D, the example smartglasses assembly 100 includes a frame 102. The frame 102 includes a front frame portion defined by rim portions 103 surrounding respective prescriptive optical portions in the form of lenses 107, with a bridge portion 109 connecting the rim portions 103. Arm portions 105 are coupled, for example, pivotably or rotatably coupled, to the front frame by hinge portions 110 at the respective rim portion 103. In some examples, the lenses 107 may be corrective/prescription lenses. In some examples, the lenses 107 may be an optical material including glass and/or plastic portions that do not necessarily incorporate corrective/prescription parameters.

A display device 104 may be coupled in a portion of the frame 102. In the example shown in FIGS. 1B and 1C, the display device 104 is coupled in the arm portion 105 of the frame 102. With the display device 104 coupled in the arm portion 105, an eye box 140 extends toward the lens(es) 107, for output of content at an output coupler 144 at which content output by the display device 104 may be visible to the user. In some examples, the output coupler 144 may be substantially coincident with the lens(es) 107. In some examples, the head mounted wearable device 100 can also include an audio output device 106 (such as, for example, one or more speakers), an illumination device 108, a sensing system 111, a control system 112, at least one processor 114, and an image capture device 116, or camera 116. The camera (or image capture device) 116 may capture images via a shutter trigger, or button; the shutter trigger is configured to cause a shutter to open to allow light reflected or scattered from a scene toward the image capture device 116 to be incident on a light detector (e.g., a charged-coupled device (CCD) array, a photomultiplier, silver halide photographic film, and the like).

In some examples, the display device 104 may include a see-through near-eye display. For example, the display device 104 may be configured to project light from a display source onto a portion of teleprompter glass functioning as a beamsplitter seated at an angle (e.g., 30-45 degrees). The beamsplitter may allow for reflection and transmission values that allow the light from the display source to be partially reflected while the remaining light is transmitted through. Such an optic design may allow a user to see both physical items in the world, for example, through the lenses 107, next to content (for example, digital images, user interface elements, virtual content, and the like) generated by the display device 104. In some implementations, waveguide optics 127 housed in the arm portion 105 may be used to depict content on the display device 104. Moreover, the waveguide optics 127 may be caused to generated collimated wavefronts for the purposes of image calibration, for example.

In some examples, the head mounted wearable device 100 may include a gaze tracking device 120 including, for example, one or more sensors 125, to detect and track eye gaze direction and movement. Data captured by the sensor(s) 125 may be processed to detect and track gaze direction and movement as a user input. In some examples, the sensing system 111 may include various sensing devices and the control system 112 may include various control system devices including, for example, one or more processors 114 operably coupled to the components of the control system 112. In some examples, the control system 112 may include a communication module providing for communication and exchange of information between the head-mounted wearable device 100 and other external devices.

Some smartglasses require calibration to set internal imaging parameters. One reason for this is to correct for possible variations in manufacture of the glasses, e.g., frame geometry, lens placement error, etc. Calibration may be accomplished using a calibration camera so that parameter values that produce the same images in different smartglasses are achieved.

Some users require prescription lenses to see properly. Similar to standard eyeglasses manufacture, a smartglasses user who requires a prescription lens may submit a prescription (e.g., SPH, CYL, Axis, power) to a manufacturer. The manufacturer then cuts, grinds, and polishes the lenses to meet the prescription within a specified tolerance. The prescription lens is then inserted into the smartglasses frame in a similar manner as in traditional eyeglasses frames. Nevertheless, a calibration step may be required to address variations in mechanical parameters that can affect image quality outside of wavefront error.

A challenge in AR is providing such image calibration to users independent of their lens prescriptions. For example, standard smartglasses form images at a fixed distance, e.g., two meters from a vertex of a world-facing surface of a world-side lens attached to the frame of the smartglasses. Nevertheless, on the one hand users who require prescription lenses should be able to see such images with their prescription lenses. On the other hand, however, prescription lenses in smartglasses may introduce wavefront aberrations at a camera used for calibrating images in smartglasses. As it would be difficult to construct a different calibration system for every prescription in use, such calibration systems use substantially aberration-free (i.e., substantially diffraction-limited) images.

A conventional approach to calibrating images in smartglasses with prescription lenses involves the use of a phoropter. A phoropter is a mechanical device used (e.g., by an optometrist) to determine a lens prescription by rapidly switching multiple lenses in front of a user's eye. For image calibration with smartglasses, however, such a phoropter may be used to determine an inverse prescription that corrects the wavefront aberrations induced by the prescription lenses. The correction parameter values determined by the phoropter may be input into calibration circuitry to cancel out the prescription. Without such a wavefront correction step, a calibration camera may not be able to evaluate image quality properly due to e.g., image distortion or large image quality differences along different meridian planes.

Nevertheless, there can be issues related to the use of a phorometer for calibrating images in the presence of prescription lenses. For example, phorometers used in image calibration may be used over large apertures and large object-image distances. Moreover, such phorometers employ a plethora of moving parts, e.g., switching out lenses of varying optical properties such as focusing power and prescription parameters such as SPH, CYL, and Axis. A technical problem with such large sizes and numbers of moving parts can render the calibration step awkward, burdensome, expensive, and unsuitable in a production environment.

It is noted for the sake of later discussion that the prescription parameters SPH, CYL, and Axis are standard parameters used to specify individual prescriptions and hence define a lens to within other physical characteristics of the lens, e.g., index of refraction, thickness, anti-reflection coatings, birefringence, etc. For example, SPH denotes an amount of power in diopters needed to correct wavefront curvature to that of a person with SPH-0. CYL refers to an amount of power in diopters needed to bring foci coincident in a pair of meridional planes and is used to correct astigmatism. Axis refers to an angle in degrees between the pair of meridional planes.

In accordance with the implementations described herein, a technical solution to the above-described technical problem includes correcting wavefront error at a calibration camera by performing a phase modulation of optical wavefronts emanating from the back surface of a prescription lens in a smartglasses assembly prior to the optical wavefronts being detected by the calibration camera. For example, when collimated light from, e.g., a waveguide disposed within a rim portion of a smartglasses frame, is incident on a prescription lens, that lens induces a wavefront aberration that would be corrected in the prescribed user's eye. In an image calibration, however, there is no such correcting eye so a correction mechanism that corrects the wavefront aberration should be placed in an eye plane related to a location of an eye of the user when the user wears the smartglasses assembly. In some implementation, the mechanism includes a compensating phase modulation device such as a phase spatial light modulator (SLM). The phase defined by the compensating phase modulation device essentially replaces the user's eye in correcting the wavefront aberrations. The difference is, for the user the corrected wavefronts are detected by the user's retina, while in image calibration the corrected wavefronts are detected by a calibration camera.

A technical advantage of the technical solution is that the phase modulation uses no mechanical moving parts and may be compact, simplifying and lowering cost of calibration of smartglasess with prescription lenses. For example, as will be shown in this document, the correction of the wavefront aberrations induced by the prescription lenses may be automated in contrast to the conventional approaches using a phorometer.

In some implementations, the trained model includes a convolutional regression neural network that is trained based on a dataset including sequences of two-dimensional images and corresponding values of the biological metric, e.g., PI change.

In some implementations, the LEDs are arranged on either side (e.g., left and right) of the detector. In some implementations, the detector forma a left channel and a right channel for radiation emitted from the LEDs. The sequence of two-dimensional images then includes a left sequence and a right sequence from which the PI change is determined.

In some implementations, the phase SLM is a transmissive phase SLM. In such implementations, the corrected wavefronts propagate to the calibration camera in a direction away from the eye plane.

In some implementations, the phase SLM is a reflective phase SLM. In such implementations, the image calibration system further comprises a beam splitter such that the corrected wavefronts propagate to the beam splitter away from the eye plane in a direction opposite the direction in which the distorted wavefronts propagate and the corrected wavefronts further propagate away from the beam splitter to the calibration camera in a direction substantially normal to the direction in which the distorted wavefronts propagate. In some implementations, the image calibration system further includes a relay optical system positioned between the beam splitter and the reflective phase SLM, the relay optical system being configured to reimage an eyebox defined by a pupil diameter at the eye plane to produce a reduced imaged pupil diameter at the calibration camera.

In some implementations, the prescription lens is represented by values of a plurality of prescription lens parameters corresponding to the user. In such implementations, generating the compensating phase modulation includes computing a wavefront error of a distorted wavefront at the eye plane based on the values of the plurality of prescription lens parameters. In some implementations, computing the wavefront error of the distorted wavefront at the eye plane includes generating coefficients of Zernike polynomials in terms of the plurality of prescription lens parameters, the Zernike polynomials being evaluated over a circular region defined by a diameter of a pupil of the eye of the user.

In some implementations, the corrected wavefront resulting from the SLM is sampled by a wavefront sensor. The wavefront signal could be sampled by the sensor through a beam splitter. The sampled results are feed back to the SLM to provide better wavefront correction.

In some implementations, the eye plane is coincident with a pupil of the eye of the user.

In some implementations, the eye plane is coincident with a center of rotation of the eye of the user.

In some implementations in which the distorted wavefronts are first distorted wavefronts, the prescription lens is represented by values of a plurality of prescription lens parameters corresponding to the user, the plurality of prescription lens parameters including SPH, CYL, and Axis, and causing the compensating phase modulation to interfere with the distorted wavefronts at the eye plane produces interim corrected wavefronts represented by CYL and Axis values substantially equal to zero, the interim corrected wavefronts propagating in the direction toward a tunable lens, producing the corrected wavefronts further includes causing the tunable lens to produce, from the interim corrected wavefronts, the corrected wavefronts having a SPH value substantially equal to zero.

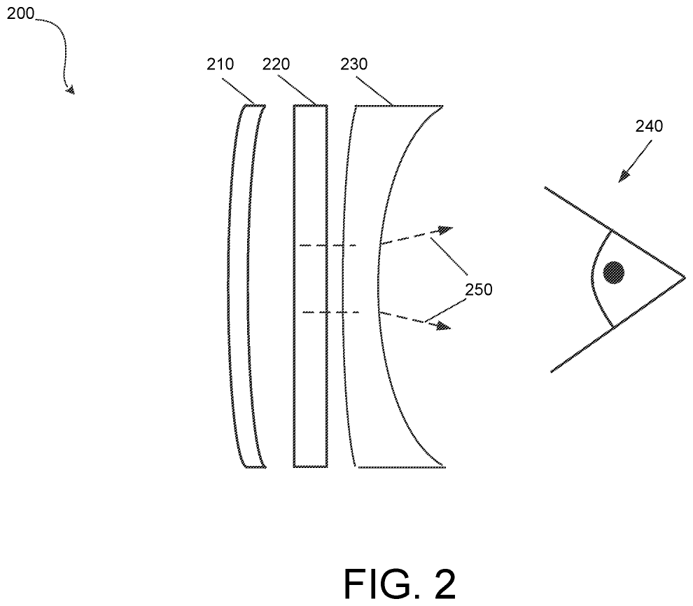

FIG. 2 is a diagram illustrating an example optical system 200 in a smartglasses assembly used to form a display image to a user having a prescription lens. As shown in FIG. 2, the optical system 200 includes a world-side-facing lens 210, a waveguide 220, and a prescription lens 230.

The world-side-facing lens 210 is attached to the frame of the smartglasses assembly and is configured to provide an image at the eye 240 of a user at an apparent fixed distance. In some implementations, the apparent fixed distance is about two meters from a vertex of a world-facing surface of the world-side lens 210. That is, the world-side-facing lens 210 is a simple, well-corrected lens having a focusing power of 0.5 diopters.

The waveguide 220 is configured to produce, as nominal wavefronts, collimated electromagnetic radiation (e.g., optical radiation or light) in response to a request generated by processing circuitry. For example, the frame 102 includes left and right arm portions 105 housing a source of beams of input radiation and rim portions 103 housing the waveguide 220. The beams of input radiation propagate in a direction parallel to a normal to the waveguide upon receipt of a request causing such propagation. These beams are coupled into the waveguide 220 via an incoupler such that, at an outcoupler of the waveguide 220, beams of output radiation 250 propagate in a direction substantially parallel to the respective beams of input radiation.

In some implementations, the waveguide 220 is configured to produce, as nominal wavefronts, non-collimated electromagnetic radiation (e.g., optical radiation or light) in response to a request generated by processing circuitry. In one example, the waveguide 220 may produce nominal wavefronts focused at a finite point along the axis. In another example, the waveguide 220 may produce nominal wavefronts according to a specified phase distribution across an entrance pupil of the optical system 200.

The prescription lens 230 is a lens inserted into the smartglasses assembly 100, i.e., mounted in a lens holder portion of the frame 102, to form corrected images at the retina of the user's eye 240. In some implementations, the wavefront aberration induced by the prescription lens 230 is expressed as values of a plurality of prescription parameters. In some implementations, the plurality of prescription parameters includes SPH, CYL, and Axis. In some implementations, the plurality of prescription parameters includes other standard prescription parameters including OD (oculus dexter indicating the right eye), OS (oculus sinister indicating the left eye), and IPD (inter-pupillary distance).

As shown in FIG. 2, the collimated wavefronts generated by the waveguide 220 are refracted by the prescription lens 230 according to the plurality of prescription parameters by which the prescription lens 230 is designed and manufactured. The light refracted by the prescription lens converts the collimated wavefronts to aberrated, or distorted wavefronts having some amount and form of wavefront aberrations. The plurality of prescription parameters are defined such that those wavefront aberrations are corrected before the wavefronts are incident with the retina of the eye 240.

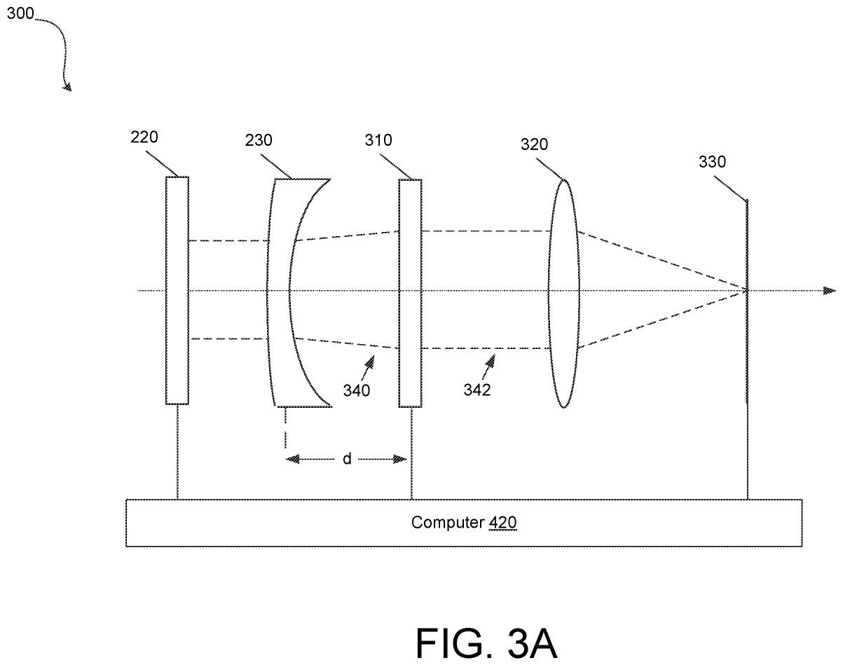

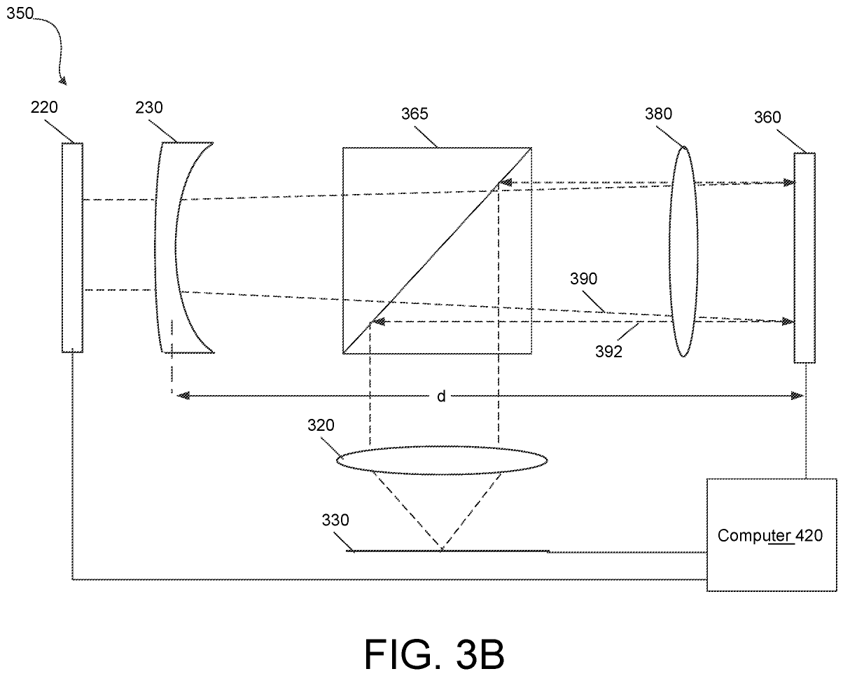

FIG. 3A is a diagram illustrating an example smartglasses image calibration system 300 that uses, as the compensating phase modulation device, a transmissive phase spatial light modulator (SLM) 310. As shown in FIG. 3A, the smartglasses image calibration system 300 includes the transmissive SLM 310, a focusing lens 320, a calibration camera 330, and a computer 420.

The transmissive phase SLM 310 is configured to correct the aberrated wavefront (represented by ray 340) generated by the prescription lens 230 based on collimated wavefront input from the waveguide 220. In some implementations, the transmissive phase SLM 310 is placed at a distance d from a principal plane of the prescription lens 230. In some implementations, the transmissive phase SLM 310 is placed at a distance d from a vertex of the prescription lens 230. The transmissive phase SLM 310, in some implementations, works by nematic liquid crystals to produce an electrically controlled birefringence effect and in effect vary an index of refraction to apply an appropriate phase delay at a spatial position. In some implementations, the transmissive phase SLM 310 produces a phase delay using a feedback system in the computer 420 based on an image quality metric at the calibration camera 330, e.g., minimum spot size, maximum modulation transfer function (MTF) area.

In some implementations, the transmissive phase SLM 310 produces a phase delay based directly on the value of the wavefront phase in the eye plane (e.g., eye pupil plane or eye center of rotation). This value of the wavefront phase at the transmissive phase SLM 310 is determined mathematically based on the plurality of prescription parameters, e.g., SPH, CYL, and Axis. In some implementations, the value of the wavefront phase at the transmissive phase SLM 310 is expressed in terms of point, angle, or mixed characteristics. In some implementations, the value of the wavefront phase at the transmissive phase SLM 310 is expressed in terms of Seidel polynomials. In some implementations, the value of the wavefront phase at the transmissive phase SLM 310 is expressed in terms of Zernike polynomials Zₙ^{m} (Zernike circle polynomials).

The Zernike polynomials are commonly used in lens design and other optical applications for expressing wavefront aberrations. An advantage of using Zernike polynomials over other expressions such as Seidel polynomials is that the Zernike polynomials form an orthogonal basis set of polynomials over the unit disk (i.e., pupil with radius normalized to unity). As a result, it is much easier to compute image metrics, e.g., encircled energy, MTF, etc., using Zernike polynomials than it is to use Seidel or other polynomials defined over the unit disk.

The second-order (n=2) Zernike polynomials which correspond to the prescription parameters SPH(s), CYL (c), and Axis (a) are expressed in polar coordinates as follows

$${Z}_{2}^{- 2} ( ρ , φ ) = {ρ}^{2} sin 2 φ ,$$

$${Z}_{2}^{0} ( ρ , φ ) = 2 {ρ}^{2} - 1 ,$$

$${Z}_{2}^{2} ( ρ , φ ) = {ρ}^{2} cos 2 φ .$$

The wavefront aberration generated at the transmissive phase SLM 310 is expressed as follows:

$$W ( ρ , φ ) = {C}_{2}^{- 2} {Z}_{2}^{- 2} ( ρ , φ ) + {C}_{2}^{0} {Z}_{2}^{0} ( ρ , φ ) + {C}_{2}^{2} {Z}_{2}^{2} ( ρ , φ ) ,$$

$$where {C}_{2}^{- 2} = \frac{{R}^{2}}{4} ( \frac{1}{\frac{1}{s + c} - d} - \frac{1}{\frac{1}{s} - d} ) sin 2 α ,$$

$${C}_{2}^{0} = \frac{{R}^{2}}{8} ( \frac{1}{\frac{1}{s + c} - d} + \frac{1}{\frac{1}{s} - d} ) ,$$

$${C}_{2}^{2} = \frac{{R}^{2}}{4} ( \frac{1}{\frac{1}{s + c} - d} - \frac{1}{\frac{1}{s} - d} ) cos 2 α ,$$

where R is the eye pupil diameter. That is, after propagating through the transmissive phase SLM 310, the wavefronts (represented by ray 340) are corrected to produce corrected wavefronts (represented by ray 342) appropriate for image calibration at the calibration camera 330 upon focusing by convergent lens 320. Note that, to simulate the world-side-lens 210, the focusing power of the convergent lens 320 is substantially 0.5 diopters. In some implementations and as shown in FIG. 3A, the corrected wavefronts propagate to the calibration camera 330 in the direction away from the eye plane, i.e., transmissive phase SLM 310, i.e., the same direction as the direction of propagation of the distorted wavefronts.

FIG. 3B is a diagram that illustrates an example smartglasses image calibration system 350 that uses a reflective phase spatial light modulator 360. As shown in FIG. 3B, the smartglasses image calibration system 350 includes the reflective phase SLM 360, a beam splitter (BS) 365, the convergent lens 320, the calibration camera 330, and computer 420. In some implementations, the smartglasses image calibration system 350 includes a relay optical system positioned between the BS 365 and the reflective phase SLM 360, the relay optical system 380 being configured to reimage an eyebox defined by a pupil diameter at the eye plane to produce a reduced imaged pupil diameter at the calibration camera 330.

The reflective phase SLM 360 is configured to correct the aberrated wavefront (represented by ray 340) generated by the prescription lens 230 based on collimated wavefront input from the waveguide 220. In some implementations, the reflective phase SLM 360 is placed at a distance d from a principal plane of the prescription lens 230. In some implementations, the reflective phase SLM 360 is placed at a distance d from a vertex of the prescription lens 230. The reflective phase SLM 360, in some implementations, works by varying a distance and/or tilt of a pixel micromirror to apply an appropriate phase delay at a spatial position. In some implementations, the reflective phase SLM 360 produces a phase delay using a feedback system in the computer 420 based on an image quality metric at the calibration camera 330, e.g., minimum spot size, maximum modulation transfer function (MTF) area.

In some implementations, the reflective phase SLM 360 produces a phase delay based directly on the value of the wavefront phase in the eye plane (e.g., eye pupil plane or eye center of rotation). This value of the wavefront phase at the reflective phase SLM 360 is determined mathematically based on the plurality of prescription parameters, e.g., SPH, CYL, and Axis. In some implementations, the value of the wavefront phase at the reflective phase SLM 360 is expressed in terms of point, angle, or mixed characteristics. In some implementations, the value of the wavefront phase at the reflective phase SLM 360 is expressed in terms of Seidel polynomials. In some implementations, the value of the wavefront phase at the reflective phase SLM 360 is expressed in terms of Zernike polynomials Zₙ^{m} (Zernike circle polynomials) as described above with regard to FIG. 3A.

It is noted that aberrated wavefronts (traveling along ray 390) are converted to corrected wavefronts traveling along ray 392, parallel to an axis of symmetry of the prescription lens 230. The BS 365, which allowed the distorted wavefronts to propagate without a change in direction to the reflective phase SLM 360, changes the direction of the corrected wavefronts to a direction substantially normal to the to the direction in which the distorted wavefronts propagate.

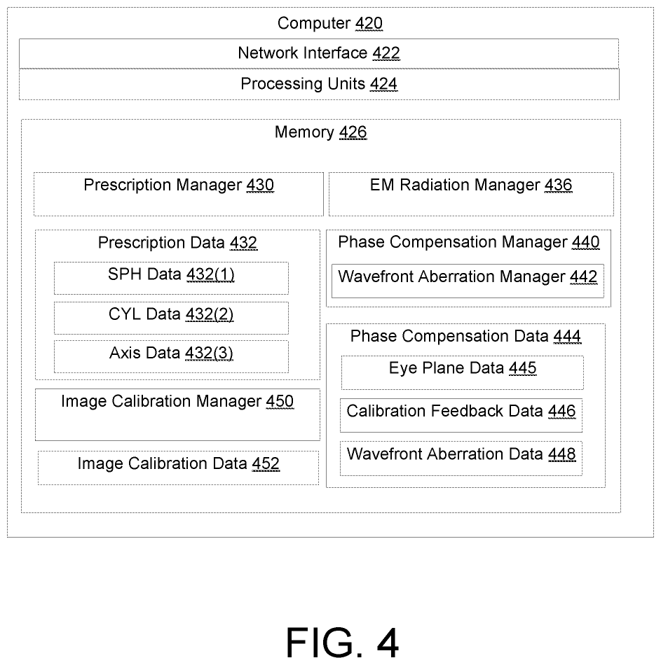

FIG. 4 is a diagram that illustrates an example computer 420 connected to the waveguide 220, the transmissive or reflective phase SLM 310 or 360, respectively, and the calibration camera 330. The computer 420 is configured to produce corrected wavefronts for measurement at the calibration camera 330 by controlling the phase in the transmissive or reflective phase SLM 310 or 360.

The computer 420 includes a network interface 422, one or more processing units 424, and nontransitory memory 426. The network interface 422 includes, for example, Ethernet adaptors, Token Ring adaptors, and the like, for converting electronic and/or optical signals received from the network to electronic form for use by the computer 420. The set of processing units 424 include one or more processing chips and/or assemblies. The memory 426 includes both volatile memory (e.g., RAM) and non-volatile memory, such as one or more ROMs, disk drives, solid state drives, and the like. The set of processing units 424 and the memory 426 together form processing circuitry, which is configured and arranged to carry out various methods and functions as described herein.

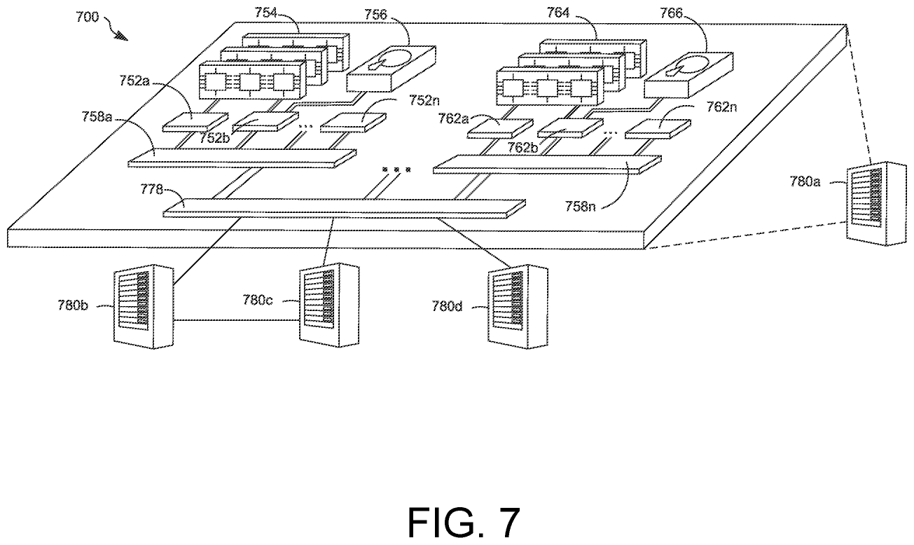

In some implementations, one or more of the components of the computer 420 can be, or can include processors (e.g., processing units 424) configured to process instructions stored in the memory 426. Examples of such instructions as depicted in FIG. 7 include a prescription manager 430, an EM manager 436, a phase compensation manager 440, and an image calibration manager 450. Further, as illustrated in FIG. 4, the memory 426 is configured to store various data, which is described with respect to the respective managers that use such data.

The prescription manager 430 is configured to obtain prescription data 432. In some implementations, the prescription manager 430 obtains the prescription data 432 over a network via the network interface 422. In some implementations, the prescription manager 430 obtains the prescription data 432 over a direct connection. In some implementations, the prescription manager 430 obtains the prescription data 432 from a local storage device.

The prescription data 432 represents values of the plurality of prescription parameters, e.g., SPH, CYL, Axis, and any others provided in a prescription for the prescription lens 230. As shown in FIG. 4, the prescription data 432 include SPH data 432 (1), CYL data 432 (2), and Axis data 432 (3). The SPH data 432 (1) is in units of diopters and in some implementations has a range between −20.00 and +20.00. The CYL data is in units of diopters and in some implementations has a range between −4.00 and +4.00. The Axis data 432 (3) is in units of degrees and in some implementations has range between 0 and 180.

The EM radiation manager 436 is configured to cause a waveguide (e.g., waveguide 220) in a smartglasses assembly (e.g., smartglasses assembly 100) to produce collimated electromagnetic radiation (e.g., optical radiation or light) in response to a request generated by the computer 420. For example, the frame 102 includes left and right arm portions 105 housing a source of beams of input radiation and rim portions 103 housing the waveguide 220. The beams of input radiation propagate in a direction parallel to a normal to the waveguide upon receipt of a request causing such propagation. These beams are coupled into the waveguide 220 via an incoupler such that, at an outcoupler of the waveguide 220, beams of output radiation 250 propagate in a direction substantially parallel to the respective beams of input radiation.

The phase compensation manager 440 is configured to produce corrected wavefronts by generating a compensating phase modulation at an eye plane related to a location of an eye of a user when the user wears the smartglasses assembly, the compensating phase modulation being configured to interfere with the distorted wavefronts at the eye plane. As shown in FIG. 4, the phase compensation manager 440 includes a wavefront aberration manager 442.

The phase compensation manager 440 is configured to produce such corrected wavefronts via phase compensation data 444. The phase compensation data 444, as shown in FIG. 4, includes eye plane data 445, calibration feedback data 446, and wavefront aberration data 448.

The eye plane data 445 specifies whether the eye plane is coincident with an eye pupil plane, a center of rotation of an eye, or some other plane (e.g., eye lens principal plane in relaxed mode). The eye plane data 445 is, in some implementations, a numeral, e.g., “0” for pupil plane, “1” for center of rotation, etc.

The calibration feedback data 446 is generated if the phase compensation manager 440 seeks to produce corrected wavefronts based on feedback from the calibration camera 330. That is, the image calibration system 300/350 may be configured to measure some characteristic of the incoming wavefronts from the phase SLM, e.g., spot size, area under MTF, Strehl ratio, and adjusts phase over the phase SLM until the characteristic has been optimized. Such a determination of the phase across the phase SLM may be performed according to, e.g., a conjugate gradient optimizer. In this case, the calibration feedback data 446 represents an identifier and value of such a characteristic.

The wavefront aberration data 448 represents values of Zernike coefficients as described above. The values of the Zernike coefficients are based on the prescription data 432 according to the equations for the Zernike coefficients. The wavefront aberration manager 442 is configured to generate thee values of the Zernike coefficients based on the prescription data 432.

The image calibration manager 450 is configured to produce image calibration data 452 from the corrected wavefronts resulting from the phase compensation data 444.

The components (e.g., modules, processing units 724) of computer 420 can be configured to operate based on one or more platforms (e.g., one or more similar or different platforms) that can include one or more types of hardware, software, firmware, operating systems, runtime libraries, and/or so forth. In some implementations, the components of the computer 420 can be configured to operate within a cluster of devices (e.g., a server farm). In such an implementation, the functionality and processing of the components of the computer 420 can be distributed to several devices of the cluster of devices.

The components of the computer 420 can be, or can include, any type of hardware and/or software configured to process attributes. In some implementations, one or more portions of the components shown in the components of the computer 420 in FIG. 4 can be, or can include, a hardware-based module (e.g., a digital signal processor (DSP), a field programmable gate array (FPGA), a memory), a firmware module, and/or a software-based module (e.g., a module of computer code, a set of computer-readable instructions that can be executed at a computer). For example, in some implementations, one or more portions of the components of the computer 420 can be, or can include, a software module configured for execution by at least one processor (not shown). In some implementations, the functionality of the components can be included in different modules and/or different components than those shown in FIG. 4, including combining functionality illustrated as two components into a single component.

Although not shown, in some implementations, the components of the computer 420 (or portions thereof) can be configured to operate within, for example, a data center (e.g., a cloud computing environment), a computer system, one or more server/host devices, and/or so forth. In some implementations, the components of the computer 420 (or portions thereof) can be configured to operate within a network. Thus, the components of the computer 420 (or portions thereof) can be configured to function within various types of network environments that can include one or more devices and/or one or more server devices. For example, the network can be, or can include, a local area network (LAN), a wide area network (WAN), and/or so forth. The network can be, or can include, a wireless network and/or wireless network implemented using, for example, gateway devices, bridges, switches, and/or so forth. The network can include one or more segments and/or can have portions based on various protocols such as Internet Protocol (IP) and/or a proprietary protocol. The network can include at least a portion of the Internet.

In some implementations, one or more of the components of the search system can be, or can include, processors configured to process instructions stored in a memory. For example, prescription manager 430 (and/or a portion thereof), an EM radiation manager 436 (and/or a portion thereof), phase compensation manager 440 (and/or a portion thereof), and image calibration manager 450 (and/or a portion thereof) are examples of such instructions.

In some implementations, the memory 426 can be any type of memory such as a random-access memory, a disk drive memory, flash memory, and/or so forth. In some implementations, the memory 426 can be implemented as more than one memory component (e.g., more than one RAM component or disk drive memory) associated with the components of the computer 420. In some implementations, the memory 426 can be a database memory. In some implementations, the memory 426 can be, or can include, a non-local memory. For example, the memory 426 can be, or can include, a memory shared by multiple devices (not shown). In some implementations, the memory 726 can be associated with a server device (not shown) within a network and configured to serve the components of the computer 420. As illustrated in FIG. 4, the memory 426 is configured to store various data, including prescription data 432, phase compensation data 444, and image calibration data 452.

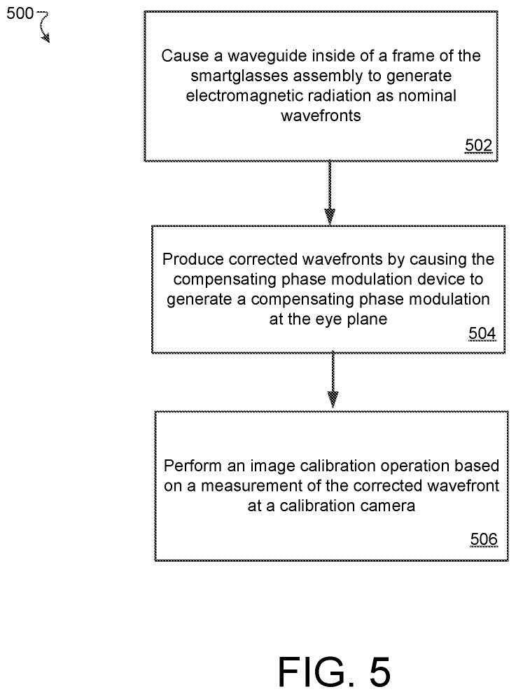

FIG. 5 is a flow chart depicting an example method 500 of producing corrected wavefronts for image calibration. The method 500 may be performed by software constructs described in connection with FIG. 4, which reside in memory 426 of the computer 420 and are run by the set of processing units 424.

At 502, the EM radiation manager 436 causes a waveguide (e.g., waveguide 220) inside of a frame (e.g., frame 102) of a smartglasses assembly (e.g., smartglasses assembly 100) to generate electromagnetic radiation as nominal wavefronts, the nominal wavefronts being refracted by a prescription lens (e.g., prescription lens 230) mounted in a lens holder portion of the frame to produce distorted wavefronts propagating in a direction toward an eye plane related to a location of an eye of a user when the user wears the smartglasses assembly.

At 504, the phase compensation manager 440 produces corrected wavefronts by generating a compensating phase modulation (e.g., at phase SLM 310/360) at the eye plane, the compensating phase modulation being configured to interfere with the distorted wavefronts at the eye plane.

At 506, the image calibration manager 450 performs an image calibration operation based on a measurement of the corrected wavefront at a calibration camera (e.g., calibration camera 330).

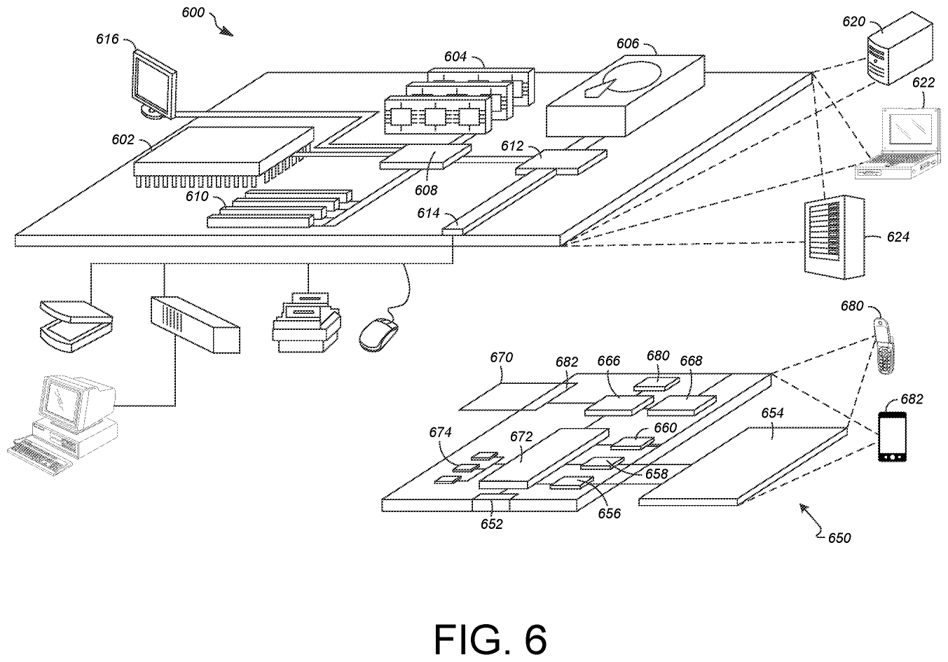

FIG. 6 illustrates an example of a generic computer device 600 and a generic mobile computer device 650, which may be used with the techniques described here. Computer device 600 is one example configuration computer 420 of FIG. 4.

As shown in FIG. 6, computing device 600 is intended to represent various forms of digital computers, such as laptops, desktops, workstations, personal digital assistants, servers, blade servers, mainframes, and other appropriate computers. Computing device 650 is intended to represent various forms of mobile devices, such as personal digital assistants, cellular telephones, smart phones, and other similar computing devices. The components shown here, their connections and relationships, and their functions, are meant to be examples only, and are not meant to limit implementations of the inventions described and/or claimed in this document.

Computing device 600 includes a processor 602, memory 604, a storage device 606, a high-speed interface 608 connecting to memory 604 and high-speed expansion ports 610, and a low speed interface 612 connecting to low speed bus 614 and storage device 606. Each of the components 602, 604, 606, 608, 610, and 612, are interconnected using various busses, and may be mounted on a common motherboard or in other manners as appropriate. The processor 602 can process instructions for execution within the computing device 600, including instructions stored in the memory 604 or on the storage device 606 to display graphical information for a GUI on an external input/output device, such as display 616 coupled to high speed interface 608. In other implementations, multiple processors and/or multiple buses may be used, as appropriate, along with multiple memories and types of memory. Also, multiple computing devices 600 may be connected, with each device providing portions of the necessary operations (e.g., as a server bank, a group of blade servers, or a multi-processor system).

The memory 604 stores information within the computing device 600. In one implementation, the memory 604 is a volatile memory unit or units. In another implementation, the memory 604 is a non-volatile memory unit or units. The memory 604 may also be another form of computer-readable medium, such as a magnetic or optical disk.

The storage device 606 is capable of providing mass storage for the computing device 600. In one implementation, the storage device 606 may be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product may also contain instructions that, when executed, perform one or more methods, such as those described above. The information carrier is a computer-or machine-readable medium, such as the memory 604, the storage device 606, or memory on processor 602.

The high speed controller 608 manages bandwidth-intensive operations for the computing device 600, while the low speed controller 612 manages lower bandwidth-intensive operations. Such allocation of functions are examples only. In one implementation, the high-speed controller 608 is coupled to memory 604, display 616 (e.g., through a graphics processor or accelerator), and to high-speed expansion ports 610, which may accept various expansion cards (not shown). In the implementation, low-speed controller 612 is coupled to storage device 606 and low-speed expansion port 614. The low-speed expansion port, which may include various communication ports (e.g., USB, Bluetooth, Ethernet, wireless Ethernet) may be coupled to one or more input/output devices, such as a keyboard, a pointing device, a scanner, or a networking device such as a switch or router, e.g., through a network adapter.

The computing device 600 may be implemented in a number of different forms, as shown in the figure. For example, it may be implemented as a standard server 620, or multiple times in a group of such servers. It may also be implemented as part of a rack server system 624. In addition, it may be implemented in a personal computer such as a laptop computer 622. Alternatively, components from computing device 600 may be combined with other components in a mobile device (not shown), such as device 650. Each of such devices may contain one or more of computing device 600, 650, and an entire system may be made up of multiple computing devices 600, 650 communicating with each other.

Computing device 650 includes a processor 652, memory 664, an input/output device such as a display 654, a communication interface 666, and a transceiver 668, among other components. The device 650 may also be provided with a storage device, such as a microdrive or other device, to provide additional storage. Each of the components 650, 652, 664, 654, 666, and 668, are interconnected using various buses, and several of the components may be mounted on a common motherboard or in other manners as appropriate.

The processor 652 can execute instructions within the computing device 650, including instructions stored in the memory 664. The processor may be implemented as a chipset of chips that include separate and multiple analog and digital processors. The processor may provide, for example, for coordination of the other components of the device 650, such as control of user interfaces, applications run by device 650, and wireless communication by device 650.

Processor 652 may communicate with a user through control interface 658 and display interface 656 coupled to a display 654. The display 654 may be, for example, a TFT LCD (Thin-Film-Transistor Liquid Crystal Display) or an OLED (Organic Light Emitting Diode) display, or other appropriate display technology. The display interface 656 may comprise appropriate circuitry for driving the display 654 to present graphical and other information to a user. The control interface 658 may receive commands from a user and convert them for submission to the processor 652. In addition, an external interface 660 may be provided in communication with processor 652, so as to enable near area communication of device 650 with other devices. External interface 660 may provide, for example, for wired communication in some implementations, or for wireless communication in other implementations, and multiple interfaces may also be used.

The memory 664 stores information within the computing device 650. The memory 664 can be implemented as one or more of a computer-readable medium or media, a volatile memory unit or units, or a non-volatile memory unit or units. Expansion memory 674 may also be provided and connected to device 650 through expansion interface 672, which may include, for example, a SIMM (Single In Line Memory Module) card interface. Such expansion memory 674 may provide extra storage space for device 650, or may also store applications or other information for device 650. Specifically, expansion memory 674 may include instructions to carry out or supplement the processes described above, and may include secure information also. Thus, for example, expansion memory 674 may be provided as a security module for device 650, and may be programmed with instructions that permit secure use of device 650. In addition, secure applications may be provided via the SIMM cards, along with additional information, such as placing identifying information on the SIMM card in a non-hackable manner.

The memory may include, for example, flash memory and/or NVRAM memory, as discussed below. In one implementation, a computer program product is tangibly embodied in an information carrier. The computer program product contains instructions that, when executed, perform one or more methods, such as those described above. The information carrier is a computer- or machine-readable medium, such as the memory 664, expansion memory 674, or memory on processor 652, that may be received, for example, over transceiver 668 or external interface 660.

Device 650 may communicate wirelessly through communication interface 666, which may include digital signal processing circuitry where necessary. Communication interface 666 may provide for communications under various modes or protocols, such as GSM voice calls, SMS, EMS, or MMS messaging, CDMA, TDMA, PDC, WCDMA, CDMA2000, or GPRS, among others. Such communication may occur, for example, through transceiver 668. In addition, short-range communication may occur, such as using a Bluetooth, WiFi, or other such transceiver (not shown). In addition, GPS (Global Positioning System) receiver module 670 may provide additional navigation- and location-related wireless data to device 650, which may be used as appropriate by applications running on device 650.

Device 650 may also communicate audibly using audio codec 660, which may receive spoken information from a user and convert it to usable digital information. Audio codec 660 may likewise generate audible sound for a user, such as through a speaker, e.g., in a handset of device 650. Such sound may include sound from voice telephone calls, may include recorded sound (e.g., voice messages, music files, etc.) and may also include sound generated by applications operating on device 650.

The computing device 650 may be implemented in a number of different forms, as shown in the figure. For example, it may be implemented as a cellular telephone 680. It may also be implemented as part of a smart phone 682, personal digital assistant, or other similar mobile device.

FIG. 7 shows an example of a generic computer device 700, which may be computer 420 of FIG. 4, which may be used with the techniques described here. Computing device 700 is intended to represent various example forms of large-scale data processing devices, such as servers, blade servers, datacenters, mainframes, and other large-scale computing devices. Computing device 700 may be a distributed system having multiple processors, possibly including network attached storage nodes, that are interconnected by one or more communication networks. The components shown here, their connections and relationships, and their functions, are meant to be examples only, and are not meant to limit implementations of the inventions described and/or claimed in this document.

Distributed computing system 700 may include any number of computing devices 780. Computing devices 780 may include a server or rack servers, mainframes, etc. communicating over a local or wide-area network, dedicated optical links, modems, bridges, routers, switches, wired or wireless networks, etc.

In some implementations, each computing device may include multiple racks. For example, computing device 780a includes multiple racks 758a, 758b, . . . , 758n. Each rack may include one or more processors, such as processors 752a, 752B, . . . , 752n and 762a, 762b, . . . , 762n. The processors may include data processors, network attached storage devices, and other computer controlled devices. In some implementations, one processor may operate as a master processor and control the scheduling and data distribution tasks. Processors may be interconnected through one or more rack switches 758, and one or more racks may be connected through switch 778. Switch 778 may handle communications between multiples of computing device 700, connected.

Each rack may include memory, such as memory 754 and memory 764, and storage, such as 756 and 766. Storage 756 and 766 may provide mass storage and may include volatile or non-volatile storage, such as network-attached disks, floppy disks, hard disks, optical disks, tapes, flash memory or other similar solid state memory devices, or an array of devices, including devices in a storage area network or other configurations. Storage 756 or 766 may be shared between multiple processors, multiple racks, or multiple computing devices and may include a computer-readable medium storing instructions executable by one or more of the processors. Memory 754 and 764 may include, e.g., volatile memory unit or units, a non-volatile memory unit or units, and/or other forms of computer-readable media, such as a magnetic or optical disks, flash memory, cache, Random Access Memory (RAM), Read Only Memory (ROM), and combinations thereof. Memory, such as memory 754 may also be shared between processors 752a, 752b, . . . , 752n. Data structures, such as an index, may be stored, for example, across storage 756 and memory 754. Computing device 700 may include other components not shown, such as controllers, buses, input/output devices, communications modules, etc.

An entire system may be made up of multiples of computing device 700 communicating with each other. For example, device 780a may communicate with devices 780b, 780c, and 780d. As another example, computer 420 of FIG. 4 may include computing device 700 or multiples thereof. Some of the computing devices may be located geographically close to each other, and others may be located geographically distant. The layout of computing device 700 is an example only and the system may take on other layouts or configurations.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (“LAN”), a wide area network (“WAN”), and the Internet.

The computing system can include clients and servers. A client and server are generally remote from each other and typically interact through a communication network. The relationship of client and server arises by virtue of computer programs running on the respective computers and having a client-server relationship to each other.

A number of implementations have been described. Nevertheless, it will be understood that various modifications may be made without departing from the spirit and scope of the specification.

It will also be understood that when an element is referred to as being on, connected to, electrically connected to, coupled to, or electrically coupled to another element, it may be directly on, connected or coupled to the other element, or one or more intervening elements may be present. In contrast, when an element is referred to as being directly on, directly connected to or directly coupled to another element, there are no intervening elements present. Although the terms directly on, directly connected to, or directly coupled to may not be used throughout the detailed description, elements that are shown as being directly on, directly connected or directly coupled can be referred to as such. The claims of the application may be amended to recite example relationships described in the specification or shown in the figures.

While certain features of the described implementations have been illustrated as described herein, many modifications, substitutions, changes and equivalents will now occur to those skilled in the art. It is, therefore, to be understood that the appended claims are intended to cover all such modifications and changes as fall within the scope of the implementations. It should be understood that they have been presented by way of example only, not limitation, and various changes in form and details may be made. Any portion of the apparatus and/or methods described herein may be combined in any combination, except mutually exclusive combinations. The implementations described herein can include various combinations and/or sub-combinations of the functions, components and/or features of the different implementations described.

In addition, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other implementations are within the scope of the following claims.

What is claimed is:

1. A method comprising:
causing, by processing circuitry, a waveguide inside of a frame of a smartglasses assembly to generate electromagnetic radiation as a nominal wavefront, the nominal wavefront being refracted by a prescription lens mounted in a lens holder portion of the frame to produce a distorted wavefront propagating in a direction toward an eye plane related to a location of an eye of a user when the user wears the smartglasses assembly;
producing a corrected wavefront by generating a compensating phase modulation at the eye plane, the compensating phase modulation being configured to interfere with the distorted wavefront at the eye plane; and
performing an image calibration operation based on a measurement of the corrected wavefront at a calibration camera.

2. The method as in claim 1, wherein the compensating phase modulation is generated using a phase spatial light modulator (SLM).

3. The method as in claim 2, wherein the phase SLM is a transmissive phase SLM, and
wherein the corrected wavefront propagates to the calibration camera in the direction away from the eye plane.

4. The method as in claim 1, wherein the prescription lens is represented by values of a plurality of prescription lens parameters corresponding to the user, and
wherein generating the compensating phase modulation includes:
computing a wavefront error of a distorted wavefront at the eye plane based on the values of the plurality of prescription lens parameters.

5. The method as in claim 4, wherein computing the wavefront error of the distorted wavefront at the eye plane includes:
generating coefficients of Zernike polynomials in terms of the plurality of prescription lens parameters, the Zernike polynomials being evaluated over a circular region defined by a diameter of a pupil of the eye of the user.

6. The method as in claim 1, wherein the nominal wavefront is a collimated wavefront.

7. The method as in claim 1, wherein the distorted wavefront is a first distorted wavefront,
wherein the prescription lens is represented by values of a plurality of prescription lens parameters corresponding to the user, the plurality of prescription lens parameters including SPH, CYL, and Axis,
wherein the compensating phase modulation at the eye plane produces an interim corrected wavefront equivalent to that produced by a lens having CYL and Axis values substantially equal to zero, the interim corrected wavefront propagating in the direction toward a tunable lens, and
wherein producing the corrected wavefront further includes:
causing the tunable lens to produce, from the interim corrected wavefront, the corrected wavefront being equivalent to that produced by a lens having a SPH value substantially equal to zero.

8. An image calibration system for a smartglasses assembly, comprising:
a compensating phase modulation device at an eye plane related to a location of an eye of a user when the user wears the smartglasses assembly,
a calibration camera, and
at least one processor configured to:
cause a waveguide inside of a frame of the smartglasses assembly to generate electromagnetic radiation as a nominal wavefront, the nominal wavefront being refracted by a prescription lens mounted in a lens holder portion of the frame to produce a distorted wavefront propagating in a direction toward an eye plane related to a location of an eye of a user when the user wears the smartglasses assembly;
produce a corrected wavefront by causing the compensating phase modulation device to generate a compensating phase modulation at the eye plane, the compensating phase modulation being configured to interfere with the distorted wavefront at the eye plane; and
perform an image calibration operation based on a measurement of the corrected wavefront at the calibration camera.

9. The image calibration system as in claim 8, wherein the compensating phase modulation device includes a phase spatial light modulator (SLM).

10. The image calibration system as in claim 9, wherein the phase SLM is a reflective phase SLM,
wherein the image calibration system further comprises a beam splitter,
wherein the corrected wavefront propagates to the beam splitter away from the eye plane in a direction opposite the direction in which the distorted wavefront propagates, and
wherein the corrected wavefront further propagates away from the beam splitter to the calibration camera in a direction substantially normal to the direction in which the distorted wavefront propagates.

11. The image calibration system as in claim 10, further comprising:
a relay optical system positioned between the beam splitter and the reflective phase SLM, the relay optical system being configured to reimage an eyebox defined by a pupil diameter at the eye plane to produce a reduced imaged pupil diameter at the calibration camera.

12. The image calibration system as in claim 8, wherein the prescription lens is represented by values of a plurality of prescription lens parameters corresponding to the user, and
wherein the at least one processor configured to generate the compensating phase modulation is further configured to:
compute a wavefront error of a distorted wavefront at the eye plane based on the values of the plurality of prescription lens parameters.

13. The image calibration system as in claim 12, wherein the at least one processor configured to compute the wavefront error of the distorted wavefront at the eye plane is further configured to:
generate coefficients of Zernike polynomials in terms of the plurality of prescription lens parameters, the Zernike polynomials being evaluated over a circular region defined by a diameter of a pupil of the eye of the user.

14. The image calibration system as in claim 8, wherein the eye plane is coincident with a center of rotation of the eye of the user.

15. The image calibration system as in claim 8, further comprising a tunable lens,
wherein the distorted wavefront is a first distorted wavefront,
wherein the prescription lens is represented by values of a plurality of prescription lens parameters corresponding to the user, the plurality of prescription lens parameters including SPH, CYL, and Axis,
wherein causing the compensating phase modulation compensating phase modulation device to generate a compensating phase modulation at the eye plane produces a first corrected wavefront being equivalent to that produced by a lens having CYL and Axis values substantially equal to zero, the first corrected wavefront propagating in the direction toward the tunable lens, and
wherein the at least one processor configured to produce the corrected wavefront further is further configured to:
cause the tunable lens to produce, from the first corrected wavefront, the corrected wavefront being equivalent to that produced by a lens having a SPH value substantially equal to zero.

16. A computer program product comprising a nontransitory storage medium, the computer program product including code that, when executed by processing circuitry, causes the processing circuitry to perform a method, the method comprising:
causing a waveguide inside of a frame of a smartglasses assembly to generate electromagnetic radiation as a nominal wavefront, the nominal wavefront being refracted by a prescription lens mounted in a lens holder portion of the frame to produce a distorted wavefront propagating in a direction toward an eye plane related to a location of an eye of a user when the user wears the smartglasses assembly;
producing a corrected wavefront by generating a compensating phase modulation at the eye plane, the compensating phase modulation being configured to interfere with the distorted wavefront at the eye plane; and
performing an image calibration operation based on a measurement of the corrected wavefront at a calibration camera.

17. The computer program product as in claim 16, wherein the compensating phase modulation is generated using a phase spatial light modulator (SLM).

18. The computer program product as in claim 17, wherein the phase SLM is a transmissive type of phase SLM, and
wherein the corrected wavefront propagate to the calibration camera in the direction away from the eye plane.

19. The computer program product as in claim 16, wherein the prescription lens is represented by values of a plurality of prescription lens parameters corresponding to the user, and
wherein generating the compensating phase modulation includes:
computing a wavefront error of a distorted wavefront at the eye plane based on the values of the plurality of prescription lens parameters.

20. The computer program product as in claim 19, wherein computing the wavefront error of the distorted wavefront at the eye plane includes:
generating coefficients of Zernike polynomials in terms of the plurality of prescription lens parameters, the Zernike polynomials being evaluated over a circular region defined by a diameter of a pupil of the eye of the user.
